(19) United States
(12) Patent Application Publication
(10) Pub. No.: US 2025/0030044 A1
(43) Pub. Date: Jan. 23, 2025

(54) ALL SOLID BATTERY

(71) Applicant: TAIYO YUDEN CO., LTD., Tokyo (JP)

(72) Inventors: Masashi SEKIGUCHI, Tokyo (JP); Daigo ITO, Tokyo (JP)

(73) Assignee: TAIYO YUDEN CO., LTD., Tokyo (JP)

(21) Appl. No.: 18/714,724

(22) PCT Filed: Oct. 28, 2022
(86) PCT No.: PCT/JP2022/040469

§ 371 Date: May 30, 2024

(30) Foreign Application Priority Data
Dec. 20, 2021 (JP) 2021-205768

(51) Int. Cl. H01M 10/0562; H01M 4/02; H01M 4/58; H01M 10/0525; H01M 10/0585

(52) U.S. Cl. CPC H01M 10/0562; H01M 4/5825; H01M 10/0585; H01M 2004/027; H01M 2004/028; H01M 10/0525; H01M 2300/0068

(57) ABSTRACT

An all solid battery includes a solid electrolyte layer including a first solid electrolyte, a positive electrode layer provided on a first main face of the solid electrolyte layer and including a positive electrode active material and a second solid electrolyte, and a negative electrode layer provided on a second main face and including a negative electrode active material and a third solid electrolyte. In one of the positive electrode layer or the negative electrode layer, an average grain size of the second or the third solid electrolyte is 2.5 μm or less, and an average grain size ratio of an average rain size of the positive electrode active material to an average grain size of the second solid electrolyte or an average grain size ratio of the negative electrode active material to an average grain size of the third solid electrolyte is 0.4 or more and 10 or less.

### TECHNICAL FIELD

The present invention relates to an all solid battery.

### BACKGROUND ART

Currently, lithium ion secondary batteries are used in various fields such as consumer equipment, industrial machinery, and automobiles. However, since existing lithium ion secondary batteries contain liquid electrolyte, there is a risk that the electrolyte may leak, smoke, catch fire, or the like. Therefore, all solid lithium ion secondary batteries employing oxide-based solid electrolytes that are stable in the atmosphere are being actively developed (for example, see Patent Document 1).

### PRIOR ART DOCUMENT

### Patent Document

Patent Document 1: Japanese Patent Application Publication No. 2018-73554
Patent Document 2: Japanese Patent Application Publication No. 2021-108258

### DISCLOSURE OF THE INVENTION

### Problems to be Solved by the Invention

In order to give the oxide-based solid electrolyte desired characteristics, a sintering process using heat treatment is required.

In order to achieve favorable capacity characteristics, it is preferable that the electrode active material and the solid electrolyte in the electrode layer are filled up as densely as possible so that the electrode active material and the solid electrolyte have many contact points with each other, and mutual contact points are effectively formed through a sintering process. However, it is difficult to improve mutual dispersibility and filling properties. For example, in a multi-layered all solid battery produced by the manufacturing flow described in Patent Document 2, it is difficult to efficiently improve mutual dispersibility and filling properties when producing an electrode mixture.

The present invention has been made in view of the above problems, and an object of the present invention is to provide an all solid battery that can realize a high-density electrode layer.

### Means for Solving the Problem

An all solid battery of the present invention includes; a solid electrolyte layer that includes a first solid electrolyte; a positive electrode layer that is provided on a first main face of the solid electrolyte layer and includes a positive electrode active material and a second solid electrolyte; and a negative electrode layer that is provided on a second main face of the solid electrolyte layer and includes a negative electrode active material and a third solid electrolyte, wherein, in at least one of the positive electrode layer or the negative electrode layer, an average grain size of the second solid electrolyte or the third solid electrolyte is 2.5 μm or less, and an average grain size ratio of an average rain size of the positive electrode active material to an average grain size of the second solid electrolyte or an average grain size ratio of the negative electrode active material to an average grain size of the third solid electrolyte is 0.4 or more and 10 or less.

In the at least one of the positive electrode layer or the negative electrode layer of the above-mentioned all solid battery, an area occupancy ratio of the second solid electrolyte or the third solid electrolyte in a cross section viewed from a direction orthogonal to a direction in which the positive electrode layer faces the negative electrode layer may be 25% or more and 75% or less.

The average grain size of the second solid electrolyte or the third solid electrolyte of the above-mentioned all solid battery may be 0.05 μm or more.

The porosity in the at least one of the positive electrode layer or the negative electrode layer of the above-mentioned all solid battery may be 10% or less.

The second solid electrolyte or the third solid electrolyte of the above-mentioned all solid battery may be phosphate-based solid electrolyte.

The second solid electrolyte or the third solid electrolyte of the above-mentioned all solid battery may have a NASICON type crystal structure.

In the above-mentioned all solid battery, the positive electrode active material may include Co and P.

In the above-mentioned all solid battery, the second solid electrolyte or the third solid electrolyte may include Co.

In the above-mentioned all solid battery, the positive electrode active material may include at least one of LiCoPO₄, LiCo₂P₃O₁₀, Li₂CoP₂O₇ or Li₆Co₅(P₂O₇)₄.

### Effects of the Invention

According to the present invention, it is possible to provide an all solid battery capable of achieving a high density electrode layer.

### BRIEF DESCRIPTION OF THE DRAWINGS

FIG. 1 is a schematic cross-sectional view illustrating a basic structure of an all solid battery;

FIG. 2 illustrates details of a positive electrode layer and a negative electrode layer;

FIG. 3A is a diagram plotting a relationship between a porosity and its overall conductivity;

FIG. 3B illustrates a relationship of a porosity and a capacity retention rate;

FIG. 4 illustrates a schematic cross section of a stack type all solid battery;

FIG. 5 illustrates a schematic cross section of another stack type all solid battery;

FIG. 6 illustrates a flow of a manufacturing method of an all solid battery; and

FIG. 7A and FIG. 7B illustrate a stacking process.

### BEST MODES FOR CARRYING OUT THE INVENTION

A description will be given of an embodiment with reference to the accompanying drawings.

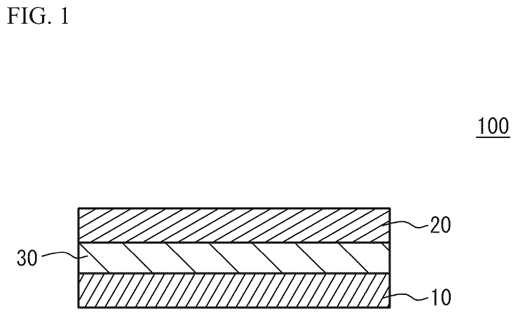

(Embodiment) FIG. 1 is a schematic cross-sectional view illustrating the basic structure of an all solid battery 100. As illustrated in FIG. 1, the all solid battery 100 has a structure in which a solid electrolyte layer 30 is sandwiched between a positive electrode layer 10 and a negative electrode layer 20. The positive electrode layer 10 is formed on a first main face of the solid electrolyte layer 30. The negative electrode layer 20 is formed on a second main face of the solid electrolyte layer 30.

The solid electrolyte layer 30 has a solid electrolyte (first solid electrolyte) having ionic conductivity as a main component. The solid electrolyte of the solid electrolyte layer 30 is, for example, an oxide-based solid electrolyte having lithium ion conductivity. The solid electrolyte is, for example, a phosphate solid electrolyte having a NASICON structure. The phosphoric acid salt-based solid electrolyte having the NASICON structure has a high conductivity and is stable in normal atmosphere. The phosphoric acid salt-based solid electrolyte is, for example, such as a salt of phosphoric acid including lithium. The phosphoric acid salt is not limited. For example, the phosphoric acid salt is such as composite salt of phosphoric acid with Ti (for example LiTi₂(PO₄)₃). Alternatively, at least a part of Ti may be replaced with a transition metal of which a valence is four, such as Ge, Sn, Hf, or Zr. In order to increase an amount of Li, a part of Ti may be replaced with a transition metal of which a valence is three, such as Al, Ga, In, Y or La. In concrete, the phosphoric acid salt including lithium and having the NASICON structure is Li₁₊ₓAlₓGe₂₋ₓ(PO₄)₃, Li₁₊ₓAlₓZr₂₋ₓ(PO₄)₃, Li₁₊ₓAlₓT₂₋ₓ(PO₄)₃ or the like. For example, a Li—Al—Ge—PO₄-based material to which the same transition metal as that contained in the phosphate having an olivine crystal structure contained in the positive electrode layer 10 and the negative electrode layer 20 is added in advance is preferable. For example, when the positive electrode layer 10 and the negative electrode layer 20 contain a phosphate containing Co and Li, it is preferable that the solid electrolyte layer 30 may contain a Li—Al—Ge—PO₄ material to which Co has been added in advance. In this case, the effect of suppressing elution of the transition metal contained in the electrode active material into the electrolyte can be obtained. When the positive electrode layer 10 and the negative electrode layer 20 contain a phosphate containing a transition element other than Co and Li, it is preferable that the Li—Al—Ge—PO₄ material to which the transition metal has been added is added to the solid electrolyte layer 30.

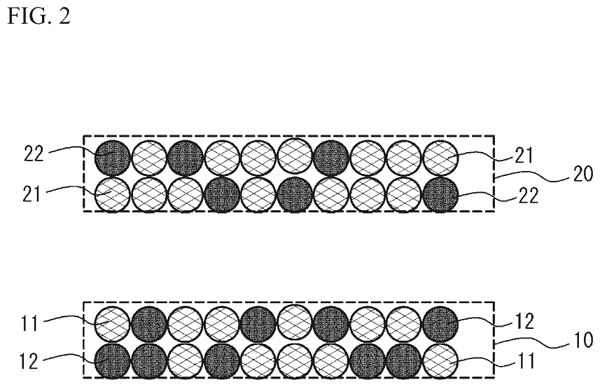

As illustrated in FIG. 2, the positive electrode layer 10 has a structure in which grains of a positive electrode active material 11, grains of a solid electrolyte 12 (second solid electrolyte), and the like are dispersed. In addition to the positive electrode active material 11 and the solid electrolyte 12, the positive electrode layer 10 may include a conductive auxiliary agent or the like. The negative electrode layer 20 has a structure in which grains of a negative electrode active material 21, grains of a solid electrolyte 22 (third solid electrolyte), and the like are dispersed. In addition to the negative electrode active material 21 and the solid electrolyte 22, the negative electrode layer 20 may include a conductive auxiliary agent or the like. Since the positive electrode layer 10 includes the positive electrode active material 11 and the negative electrode layer 20 includes the negative electrode active material 21, the all solid battery 100 can be used as a secondary battery. Since the positive electrode layer 10 includes the solid electrolyte 12 and the negative electrode layer 20 includes the solid electrolyte 22, ionic conductivity is obtained in the positive electrode layer 10 and the negative electrode layer 20. By providing the positive electrode layer 10 and the negative electrode layer 20 with a conductive auxiliary agent, the positive electrode layer 10 and the negative electrode layer 20 can have electrical conductivity.

The positive electrode active material 11 is, for example, an electrode active material having an olivine crystal structure. The electrode active material having the olivine crystal structure may also be contained in the negative electrode layer 20. The electrode active material is such as phosphates containing transition metals and lithium. The olivine crystal structure is a crystal possessed by natural olivine, and can be determined by X-ray diffraction.

As a typical example of the electrode active material having the olivine crystal structure, LiCoPO₄ containing Co and P can be used. It is also possible to use a phosphate in which the transition metal Co is replaced in this chemical formula. Here, the ratio of Li and PO₄ may vary depending on the valence. Note that it is preferable to use Co, Mn, Fe, Ni or the like as the transition metal. As a positive electrode active material containing Co and P, LiCo₂P₃O₁₀, Li₂CoP₂O₇, Li₆Co₅(P₂O₇)₄ or the like can also be used.

For example, if only the positive electrode layer 10 contains the electrode active material having the olivine crystal structure, the electrode active material acts as the positive electrode active material. When the negative electrode layer 20 also includes an electrode active material having the olivine type crystal structure, discharge capacity may increase and an operation voltage may increase because of electric discharge, in the negative electrode layer 20 acting as a negative electrode. The function mechanism is not completely clear. However, the mechanism may be caused by partial solid-phase formation together with the negative electrode active material.

When both the positive electrode layer 10 and the negative electrode layer 20 include an electrode active material having the olivine type crystal structure, the electrode active material of each of the positive electrode layer 10 and the negative electrode layer 20 may have a common transition metal. Alternatively, the transition metal of the electrode active material of the positive electrode layer 10 may be different from that of the negative electrode layer 20. The positive electrode layer 10 and the negative electrode layer 20 may have only single type of transition metal. The positive electrode layer 10 and the negative electrode layer 20 may have two or more types of transition metal. It is preferable that the positive electrode layer 10 and the negative electrode layer 20 have a common transition metal. It is more preferable that the electrode active materials of the both electrode layers have the same chemical composition. When the positive electrode layer 10 and the negative electrode layer 20 have a common transition metal or a common electrode active material of the same composition, similarity between the compositions of the both electrode layers increases. Therefore, even if terminals of the all solid battery 100 are connected in a positive/negative reversed state, the all solid battery 100 can be actually used without malfunction, in accordance with the usage purpose.

The negative electrode layer 20 functions as a negative electrode layer by including the negative electrode active material 21. By containing the negative electrode active material in only one electrode, it becomes clear that the one electrode acts as a negative electrode and the other electrode acts as a positive electrode. However, both electrodes may contain substances known as negative electrode active materials. Regarding the negative electrode active material of the electrode, conventional techniques in secondary batteries can be referred to as appropriate, and for example, compounds such as titanium oxide, lithium titanium composite oxide, lithium titanium composite phosphate, carbon, lithium vanadium phosphate or the like can be used.

The solid electrolyte 12 and the solid electrolyte 22 are not particularly limited as long as they are oxide-based solid electrolytes that have ionic conductivity. The solid electrolyte 12 and the solid electrolyte 22 are, for example, oxide-based solid electrolytes having lithium ion conductivity. The solid electrolyte is, for example, a phosphate solid electrolyte having a NASICON structure. The phosphate-based solid electrolyte is, for example, a phosphate containing lithium. The phosphate is not particularly limited, but includes, for example, a composite lithium phosphate salt with Ti (for example, LiTi₂(PO₄)₃). Alternatively, Ti can be partially or completely replaced with a tetravalent transition metal such as Ge, Sn, Hf, or Zr. Further, in order to increase the Li content, a portion of the metal may be replaced with a trivalent transition metal such as Al, Ga, In, Y, or La. More specifically, examples include Li₁₊ₓAlₓGe₂₋ₓ(PO₄)₃, Li₁₊ₓAlₓZr₂₋ₓ(PO₄)₃, and Li₁₊ₓAlₓTi₂₋ₓ(PO₄)₃. The solid electrolyte 12 and the solid electrolyte 22 can be, for example, the same as the solid electrolyte that is the main component of the solid electrolyte layer 30. Alternatively, when the electrode active material contains Co and P, it is preferable that the solid electrolytes 12 and 22 contain Co. Although the detailed mechanism is unknown, by including Co during co-firing, the oxidation resistance stability of the solid electrolyte tends to improve, thereby easily ensuring cycle stability.

A carbon material or the like may be included as a conductive auxiliary agent contained in the positive electrode layer 10 and the negative electrode layer 20. A metal may be included as the conductive auxiliary agent. Examples of the metal of the conductive auxiliary agent is such as Pd, Ni, Cu, Fe, or alloys containing at least one of these.

The solid electrolyte layer 30 is obtained by firing a solid electrolyte green sheet obtained by coating a slurry containing solid electrolyte powder. During the firing process, the solid electrolyte powder is sintered and desired properties can be obtained.

The positive electrode layer 10 and the negative electrode layer 20 are obtained by printing a paste containing an electrode active material, a solid electrolyte, and a conductive auxiliary agent and firing the paste simultaneously with the solid electrolyte green sheet.

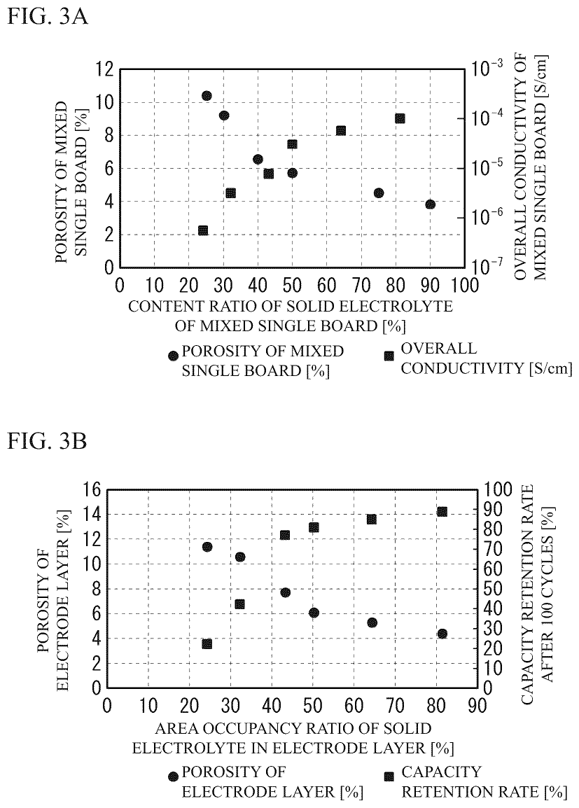

FIG. 3A is a diagram plotting the relationship between the porosity in a fired single board (electrode layer) and its overall conductivity after producing the fired single board with different mixing ratios of the electrode active material and the solid electrolyte. At each mixing ratio, the electrode active materials with the same composition and the same average grain size are used, and the solid electrolytes with the same composition and the same average grain size are used. Regarding the overall conductivity, Au was sputtered on both sides of the sample to form an electrode layer, and the measurement was performed at 25° C. under the conditions of a voltage amplitude of 30 mV and a frequency of 0.1 Hz to 500 kHz. The overall conductivity is evaluated by reading the bulk resistance and the grain boundary resistance from the obtained Nyquist plot.

As illustrated in FIG. 3A, the porosity tends to decrease by increasing the amount of the solid electrolyte. This is thought to be because the sinterability improves as the solid electrolyte increases. As the porosity decreases, the overall conductivity increases. Therefore, from the viewpoint of improving sinterability and increasing overall conductivity, it is preferable that the ratio of the solid electrolyte in the electrode layer is high.

FIG. 3B illustrates a relationship of the porosity in the electrode layer and capacity retention rate after 100 cycles with respect to an area occupancy ratio of the solid electrolyte in the electrode layer confirmed from a cross section in the stacking direction and the thickness direction, in the stacked-type all solid battery chip using the sintered single board produced in FIG. 3A as the electrode layer.

As illustrated in FIG. 3B, as the area occupation ratio of the solid electrolyte increases, the porosity tends to decrease. This is thought to be because the sinterability improves as the solid electrolyte increases. As the porosity decreases, the capacity retention rate decreases. Therefore, from the viewpoint of improving sinterability and increasing the capacity retention rate, it is preferable that the area ratio of the solid electrolyte in the electrode layer is high.

However, when the content ratio of the solid electrolyte is increased in the electrode layer, the content ratio of the electrode active material decreases, which may lead to a decrease in capacity. Therefore, it is desirable that the sinterability can be improved without increasing the content of the solid electrolyte and the electrode active material and solid electrolyte in the electrode layer are filled up as densely as possible so as to have many contact points with each other.

Therefore, at least one of the positive electrode layer 10 and the negative electrode layer 20 according to the present embodiment has a configuration that enables high-density filling up. As an example, details will be explained focusing on the positive electrode layer 10.

First, in the positive electrode layer 10, if the average grain size of the solid electrolytes 12 is too large, the filling property may be reduced, which may lead to a reduction in sinterability. Therefore, in this embodiment, an upper limit is set for the average grain size of the solid electrolytes 12 in the positive electrode layer 10. Specifically, the average grain size of the solid electrolytes 12 in the positive electrode layer 10 is 2.5 μm or less, preferably 1.5 μm or less, and more preferably 1.0 μm or less.

On the other hand, if the average grain size of the solid electrolytes 12 in the positive electrode layer 10 is too small, there is a risk that the filling property may be reduced due to aggregation. Therefore, in this embodiment, it is preferable to set a lower limit to the average grain size of the solid electrolytes 12 in the positive electrode layer 10. Specifically, the average grain size of the solid electrolytes 12 in the positive electrode layer 10 is preferably 0.05 μm or more, more preferably 0.1 μm or more, and even more preferably 0.3 μm or more.

Next, in the positive electrode layer 10, if the ratio (average grain size ratio) of the average grain size of the positive electrode active materials 11 to the average grain size of the solid electrolytes 12 is small, aggregation of the active materials may occur, resulting in a decrease in filling properties. This may cause a decrease in sinterability. Therefore, a lower limit is set for the average grain size ratio in the positive electrode layer 10. Specifically, the average grain size ratio in the positive electrode layer 10 is set to 0.4 or more, preferably 0.7 or more, and more preferably 1.0 or more. Note that the average grain size ratio in the positive electrode layer 10 is (average grain size of the positive electrode active materials 11)/(average grain size of the solid electrolytes 12).

On the other hand, in the positive electrode layer 10, if the ratio of the average grain size of the positive electrode active materials 11 to the average grain size of the solid electrolytes 12 (average particle size ratio) is large, the filling property may decrease and the sinterability may decrease due to this. Therefore, an upper limit is set for the average grain size ratio in the positive electrode layer 10. Specifically, the average grain size ratio in the positive electrode layer 10 is 10 or less, preferably 5.0 or less, and more preferably 3.0 or less.

As described above, the positive electrode layer 10 can be filled up with high density when the average grain size of the solid electrolytes 12 is 2.5 μm or less and the average grain size ratio is 0.4 or more and 10 or less. For example, the porosity of the positive electrode layer 10 is preferably 10% or less, more preferably 7% or less, and even more preferably 5% or less.

The porosity in the electrode layer can be determined by, for example, performing a cross-sectioning using a cross-section polisher (CP), acquiring 10 secondary electron images at an accelerating voltage of 5 kV with the same magnification using a scanning electron microscope (manufactured by Hitachi High-Tech Corporation, model: S-4800), and measuring the average pore area occupancy rate through image analysis.

Next, from the viewpoint of obtaining even better sinterability, it is preferable to set a lower limit to the area occupation ratio of the solid electrolyte 12 in the cross section of the positive electrode layer 10 in the thickness direction. For example, in the cross section of the positive electrode layer 10 in the thickness direction, the area occupation ratio of the solid electrolyte 12 is preferably 25% or more, more preferably 30% or more, and even more preferably 40% or more.

On the other hand, if the area occupation ratio of the solid electrolyte 12 in the cross section in the thickness direction of the positive electrode layer 10 is too large, the content ratio of the positive electrode active material 11 may decrease, leading to a decrease in capacity.

Therefore, it is preferable to set an upper limit on the area occupation ratio of the solid electrolyte 12 in the cross section of the positive electrode layer 10 in the thickness direction. In this embodiment, the area occupation ratio of the solid electrolyte 12 in the cross section in the thickness direction of the positive electrode layer 10 is preferably 75% or less, more preferably 65% or less, and even more preferably 60% or less.

The average grain size of the electrode active material and solid electrolyte in the electrode layer can be measured by the following method. First, using a cross-section polisher (CP) or the like, a cross section of the electrode layer is processed and exposed in a direction substantially perpendicular to the stacked thickness direction of the all solid battery. Next, the electrode layer is observed by using, for example, a scanning electron microscope (manufactured by Hitachi High-Tech Corporation, model: SU-7000) at an accelerating voltage of 5 kV, and the regions of active material grains and solid electrolyte grains within the positive electrode or negative electrode are determined by an SEM image at a magnification of 10,000 times and an elemental analysis by SEM-EDS. At least 10 locations are observed. Grains that exist isolated from other grains from the identified positive electrode or negative electrode active material grains and solid electrolyte grains to obtain grains sizes of at least 10 grains. Next, using image analysis software, the grain area of each selected grain are measured. The equivalent circle diameter (Heywood diameter) from the grain area. The grain size on the x-axis and the frequency on the y-axis. From the obtained grain size distribution, the median diameter (D50 value) of grains can be calculated and defined as the average grain size of the grains.

In addition, the area occupancy ratios of the electrode active material and the solid electrolyte in the electrode layer can be measured by the following method. First, using a cross-section polisher (CP) or the like, a cross section of the electrode layer is processed and exposed in a direction substantially perpendicular to the stacked thickness direction of the all solid battery. Next, the electrode layer is observed by using, for example, a scanning electron microscope (manufactured by Hitachi High-Tech Corporation, model: SU-7000) at an accelerating voltage of 5 kV, and backscattered electron images of the positive electrode layer or the negative electrode layer at the same magnification are obtained and elemental analysis are performed using SEM-EDS at 10 points. Using image analysis software, the regions of the active material and solid electrolyte occupying the acquired image can be determined, and the arithmetic average value can be calculated as each area occupancy ratio.

Although the above description focuses on the positive electrode layer 10 as an example, the negative electrode layer 20 has the same numeral range as the positive electrode layer 10 in terms of the area occupation ratio of the solid electrolyte, the average grain size of the solid electrolyte, and the average grain size ratio.

The thickness of the solid electrolyte layer 30 is, for example, 0.5 μm or more and 100 μm or less, 1 μm or more and 50 μm or less, and 2 μm or more and 20 μm or less. The thickness of the positive electrode layer 10 is, for example, 1 μm or more and 500 μm or less, 2 μm or more and 400 μm or less, and 5 μm or more and 300 μm or less. The thickness of the negative electrode layer 20 is, for example, 1 μm or more and 500 μm or less, 2 μm or more and 400 μm or less, and 5 μm or more and 300 μm or less.

The thickness of each layer can be determined by, for example, performing a cross-sectioning in a direction substantially perpendicular to the stacked thickness direction of the all solid battery using a cross-section polisher (CP) or the like, observing using a scanning electron microscope (manufactured by Hitachi High-Tech Corporation, Model: SU-7000) at an accelerating voltage of 5 kV, measuring backscattered electron images and elemental analysis using SEM-EDS at 10 points to determine the interface between each layer, and calculating the arithmetic average value of the 10 points for each layer.

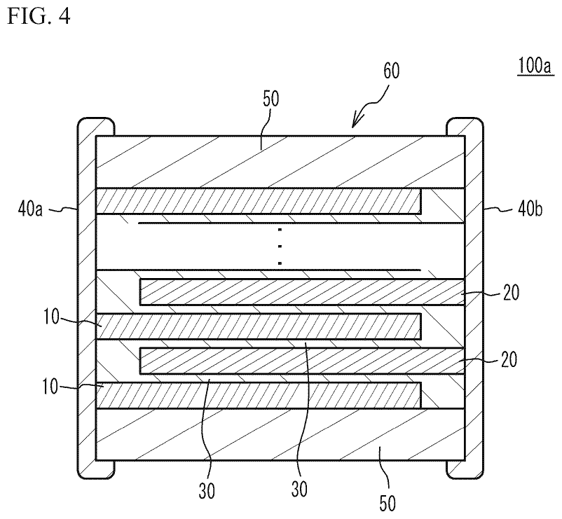

(Multilayer type all solid battery) FIG. 4 illustrates a schematic cross section of an all solid battery 100a in which a plurality of cell units are stacked. The all solid battery 100a has a multilayer chip 60 having a rectangular parallelepiped shape. In the multilayer chip 60, a first external electrode 40a and a second external electrode 40b are provided so as to be in contact with two side faces, which are two of the four faces other than the upper face and the lower face at the ends in the stacking direction. The two side faces may be two adjacent side faces or may be two side faces facing each other. In this embodiment, it is assumed that the first external electrode 40a and the second external electrode 40b are provided so as to be in contact with the two side faces (hereinafter referred to as two end faces) facing each other.

In the following description, the same numeral is added to each member that has the same composition range, the same thickness range and the same particle distribution range as that of the all solid battery 100. And, a detail explanation of the same member is omitted.

In the all solid battery 100a, the plurality of positive electrode layers 10 and the plurality of negative electrode layers 20 are alternately stacked with solid electrolyte layers 30 in between. The ends of the plurality of positive electrode layers 10 are exposed to the first end face of the multilayer chip 60 and are not exposed to the second end face. The ends of the plurality of negative electrode layers 20 are exposed to the second end face of the multilayer chip 60 and are not exposed to the first end face. Thereby, the positive electrode layer 10 and the negative electrode layer 20 are alternately electrically connected to the first external electrode 40a and the second external electrode 40b. Note that the solid electrolyte layer 30 extends from the first external electrode 40a to the second external electrode 40b. In this way, the all solid battery 100a has a structure in which a plurality of cell units are stacked.

A cover layer 50 is stacked on the upper face of the multilayer structure of the positive electrode layer 10, the solid electrolyte layer 30, and the negative electrode layer 20 (in the example of FIG. 4, on the upper face of the uppermost positive electrode layer 10). Further, the cover layer 50 is also stacked on the lower face of the multilayer structure (in the example of FIG. 4, on the lower face of the lowermost positive electrode layer 10). The cover layer 50 is mainly composed of an inorganic material (for example Al₂O₃, ZrO₂, TiO₂ or the like) containing Al, Zr, Ti or the like, for example. The cover layer 50 may contain the main component of the solid electrolyte layer 30 as a main component.

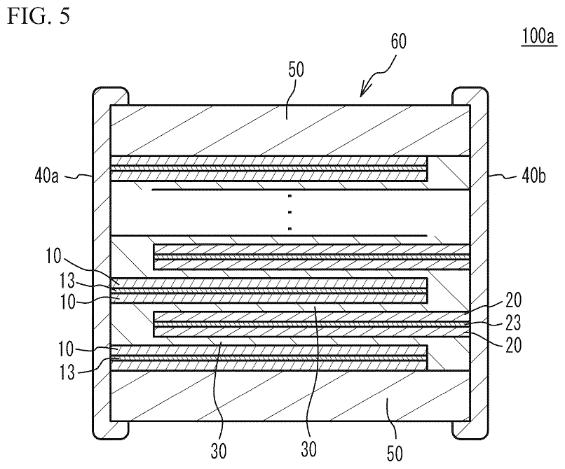

The positive electrode layer 10 and the negative electrode layer 20 may include a current collector layer. For example, as illustrated in FIG. 5, a first current collector layer 13 may be provided within the positive electrode layer 10. Further, a second current collector layer 23 may be provided within the negative electrode layer 20. The first current collector layer 13 and the second current collector layer 23 have a conductive material as a main component. For example, metal, carbon or the like can be used as the conductive material for the first current collector layer 13 and the second current collector layer 23. By connecting the first current collector layer 13 to the first external electrode 40a and connecting the second current collector layer 23 to the second external electrode 40b, current collection efficiency is improved.

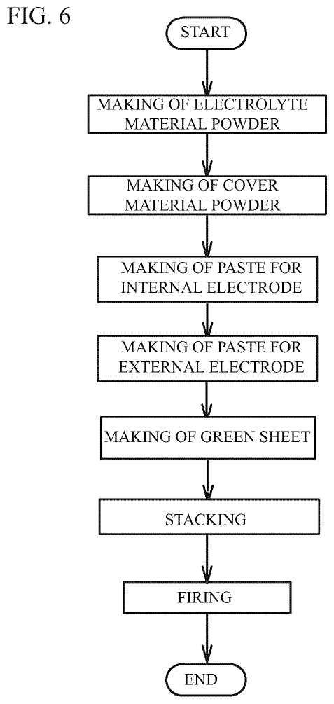

Next, a method for manufacturing the all solid battery 100a illustrated in FIG. 4 will be described. FIG. 6 is a flowchart of the method for manufacturing the all solid battery 100a.

(Making process of raw material powder for solid electrolyte layer) First, a raw material powder for a solid electrolyte layer constituting the solid electrolyte layer 30 described above is produced. For example, the raw material powder for an oxide-based solid electrolyte can be produced by mixing raw materials, additives, and so on and using a solid phase synthesis method. By dry-pulverizing the obtained raw material powder, it is possible to adjust the raw material powder to a desired average particle size. For example, the particles are adjusted to a desired average particle size using a planetary ball mill using ZrO₂ balls of 5 mm diameter.

(Making process of raw material powder for cover layer) First, a raw material powder of ceramics constituting the above-mentioned cover layer 50 is produced. For example, the raw material powder for the cover layer can be produced by mixing raw materials, additives, and so on and using a solid phase synthesis method. By dry-pulverizing the obtained raw material powder, it is possible to adjust the raw material powder to a desired average particle size. For example, the particles are adjusted to a desired average particle size using a planetary ball mill using ZrO₂ balls of 5 mm diameter. When the solid electrolyte layer 30 and the cover layer 50 have the same composition, the raw material powder for the solid electrolyte layer can be substituted.

(Making process of paste for internal electrode layer) Next, internal electrode pastes for producing the above-described positive electrode layer 10 and the negative electrode layer 20 are separately produced. For example, a paste for internal electrodes can be obtained by uniformly dispersing a conductive auxiliary agent, an electrode active material, a solid electrolyte material, a sintering aid, a binder, a plasticizer and so on in water or an organic solvent. The solid electrolyte paste described above may be used as the solid electrolyte material. A carbon material or the like is used as a conductive auxiliary agent. A metal may be used as the conductive auxiliary agent. Examples of the metal of the conductive auxiliary agent include Pd, Ni, Cu, Fe, or alloys containing these. Pd, Ni, Cu, Fe, alloys containing these, various carbon materials or the like may also be used.

As the sintering aid for the paste for internal electrode layer, for example, any one of glass component such as Li—B—O based compounds, Li—Si—O based compounds, Li—C—O based compounds, Li—S—O based compounds, and Li—P—O based compounds can be used.

In addition, in the paste for internal electrode layer, it is preferable that the average particle size of the solid electrolyte material is 2.5 μm or less. Further, it is preferable that the ratio of the average particle size of the electrode active material to the average particle size of the solid electrolyte material is within the range of 0.4 or more and 10 or less.

(Making process for paste for external electrode) Next, a paste for external electrode for the first external electrode 40a and the second external electrode 40b described above is prepared. For example, the paste for external electrode can be obtained by uniformly dispersing a conductive material, glass frit, binder, plasticizer and so on in water or an organic solvent.

(Making process of solid electrolyte green sheet) By uniformly dispersing the raw material powder for solid electrolyte layer in an aqueous or organic solvent together with a binder, dispersant, plasticizer and so on and performing wet pulverization, a solid electrolyte slurry having a desired average particle size can be created. At this time, a bead mill, a wet jet mill, various kneaders, a high-pressure homogenizer or the like can be used, and it is preferable to use a bead mill from the viewpoint of being able to adjust the particle size distribution and perform dispersion at the same time. A binder is added to the obtained solid electrolyte slurry to obtain a solid electrolyte paste. A solid electrolyte green sheet 51 can be produced by applying the obtained solid electrolyte paste. The applying method is not particularly limited, and a slot die method, reverse coating method, gravure coating method, bar coating method, doctor blade method or the like can be used. The particle size distribution after wet pulverization can be measured using, for example, a laser diffraction measuring device using a laser diffraction scattering method.

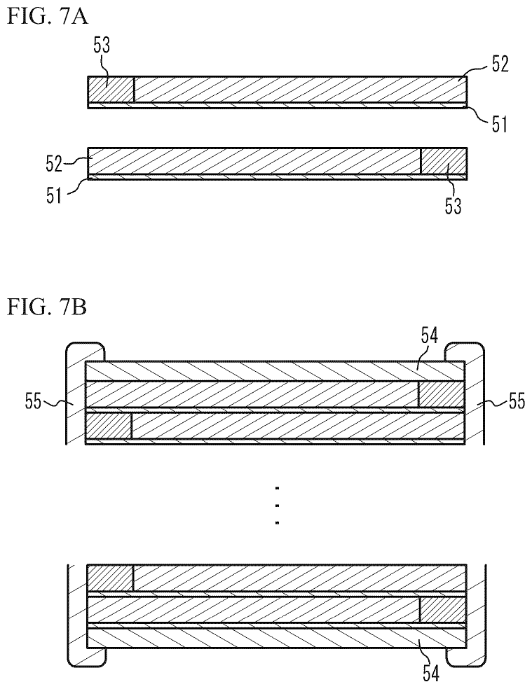

(Stacking process) As illustrated in FIG. 7A, an internal electrode paste 52 is printed on one side of the solid electrolyte green sheet 51. A reverse pattern 53 is printed on the solid electrolyte green sheet 51 in an area where the internal electrode paste 52 is not printed. As the reverse pattern 53, the same one as the solid electrolyte green sheet 51 can be used. The plurality of solid electrolyte green sheets 51 after printing are stacked in an alternately staggered manner. As illustrated in FIG. 7B, a multilayer structure is obtained by pressing a cover sheet 54 from above and below in the stacking direction. In this case, the multilayer structure is shaped into a substantially rectangular parallelepiped so that the internal electrode paste 52 for the positive electrode layer 10 is exposed on one end face, and the internal electrode paste 52 for the negative electrode layer 20 is exposed on the other end face. The cover sheet 54 can be formed by applying raw material powder for the cover layer using a method similar to the making process of the solid electrolyte green sheet. The cover sheet 54 is formed thicker than the solid electrolyte green sheet 51. The thickness may be increased at the time of coating, or by stacking a plurality of coated sheets.

Next, an external electrode paste 55 is applied to each of the two end faces by a dipping method or the like and dried. Thereby, a compact for forming the all solid battery 100a is obtained.

(Firing process) Next, the obtained multilayer structure is fired. The firing conditions are not particularly limited, such as under an oxidizing atmosphere or a non-oxidizing atmosphere, with a maximum temperature of preferably 400° C. to 1000° C., more preferably 500° C. to 900° C. In order to sufficiently remove the binder before reaching the maximum temperature, a step of maintaining the temperature lower than the maximum temperature in an oxidizing atmosphere may be provided. In order to reduce process costs, it is desirable to fire at as low a temperature as possible. After firing, re-oxidation process may be performed. Through the above steps, the all solid battery 100a is produced.

Note that the current collector layer can be formed in each of the positive electrode layer 10 and the negative electrode layer 20 by sequentially stacking the internal electrode paste, the current collector paste containing a conductive material, and the internal electrode paste.

### Example

Hereinafter, all solid batteries were produced according to the embodiment, and their characteristics were investigated.

(Examples 1 to 6 and Comparative Examples 1 to 3) LiCoPO₄ was used as the positive electrode active material, LAGP was used as the solid electrolyte, and Co₃O₄ was used as the Co source added to the solid electrolyte. The positive electrode active material, the electron conduction aid, the solid electrolyte, and Co₃O₄ were weighed so that the mass ratio of them was 35:10:54.5:0.5. And the dispersant, the plasticizer, the organic solvent, and the organic binder were added. The mixture was kneaded to prepare the internal electrode paste for the positive electrode layer.

TiO₂ was used as the negative electrode active material and LAGP was used as the solid electrolyte. The negative electrode active material, the electron conduction aid, and the solid electrolyte were weighed so that the mass ratio of them was 35:10:55. And the dispersant, the plasticizer, the organic solvent, and the organic binder were added and kneaded to form the negative electrode layer. Thus the paste for internal electrodes was prepared.

A solid electrolyte green sheet was produced using LAGP as the solid electrolyte and a slurry consisting of the organic binder, the dispersant, the plasticizer, and the organic solvent.

The internal electrode paste for the positive electrode layer was applied and formed on the first solid electrolyte green sheet by screen printing. The internal electrode paste for the negative electrode layer was applied and formed on the second solid electrolyte green sheet by a screen printing method. The internal electrode paste for the positive electrode layer and the internal electrode paste for the negative electrode layer were made to have the same thickness. The plurality of first solid electrolyte green sheets and the plurality of second solid electrolyte green sheets were stacked so that the positive electrode layer and the negative electrode layer were drawn out alternately from side to side to obtain a green chip for the stacked all solid batteries. The green chips were sintered by degreasing and firing, and external electrodes were formed by applying and curing an external electrode paste to obtain the stacked all solid batteries.

For each of Examples 1 to 6 and Comparative Examples 1 to 3, the average grain size of the electrode active material in the positive electrode layer (positive electrode active material) and the electrode active material in the negative electrode layer (negative electrode active material) was measured. In addition, the average grain size of the solid electrolyte in the positive electrode layer and the average grain size of the solid electrolyte in the negative electrode layer were measured. In each of the positive electrode layer and the negative electrode layer, the average grain size ratio of the electrode active material to the average grain size of the solid electrolyte (average particle size ratio) was measured.

In Example 1, the average grain size of the positive electrode active material in the positive electrode layer and the average grain size of the negative electrode active material in the negative electrode layer were 0.98 μm. The average grain size of the solid electrolyte in the positive electrode layer and the average grain size of the solid electrolyte in the negative electrode layer were 0.79 μm. The average grain size ratio in each of the positive electrode layer and the negative electrode layer was 1.24.

In Example 2, the average grain size of the positive electrode active material in the positive electrode layer and the average grain size of the negative electrode active material in the negative electrode layer were 3.02 μm. The average grain size of the solid electrolyte in the positive electrode layer and the average grain size of the solid electrolyte in the negative electrode layer were 0.79 μm. The average grain size ratio in each of the positive electrode layer and the negative electrode layer was 3.82.

In Example 3, the average grain size of the positive electrode active material in the positive electrode layer and the average grain size of the negative electrode active material in the negative electrode layer were 0.98 μm. The average grain size of the solid electrolyte in the positive electrode layer and the average grain size of the solid electrolyte in the negative electrode layer were 1.05 μm. The average grain size ratio in each of the positive electrode layer and the negative electrode layer was 0.93.

In Example 4, the average grain size of the positive electrode active material in the positive electrode layer and the average grain size of the negative electrode active material in the negative electrode layer were 0.98 μm. The average grain size of the solid electrolyte in the positive electrode layer and the average grain size of the solid electrolyte in the negative electrode layer were 2.21 μm. The average grain size ratio in each of the positive electrode layer and the negative electrode layer was 0.44.

In Example 5, the average grain size of the positive electrode active material in the positive electrode layer and the average grain size of the negative electrode active material in the negative electrode layer were 6.99 μm. The average grain size of the solid electrolyte in the positive electrode layer and the average grain size of the solid electrolyte in the negative electrode layer were 0.79 μm. The average grain size ratio in each of the positive electrode layer and the negative electrode layer was 8.85.

In Example 6, the average grain size of the positive electrode active material in the positive electrode layer and the average grain size of the negative electrode active material in the negative electrode layer were 0.49 μm. The average grain size of the solid electrolyte in the positive electrode layer and the average grain size of the solid electrolyte in the negative electrode layer were 0.79 μm. The average grain size ratio in each of the positive electrode layer and the negative electrode layer was 0.62.

In Comparative Example 1, the average grain size of the positive electrode active material in the positive electrode layer and the average grain size of the negative electrode active material in the negative electrode layer were 0.98 μm. The average grain size of the solid electrolyte in the positive electrode layer and the average grain size of the solid electrolyte in the negative electrode layer were 2.66 μm. The average grain size ratio in each of the positive electrode layer and the negative electrode layer was 0.37.

In Comparative Example 2, the average grain size of the positive electrode active material in the positive electrode layer and the average grain size of the negative electrode active material in the negative electrode layer were 8.13 μm. The average grain size of the solid electrolyte in the positive electrode layer and the average grain size of the solid electrolyte in the negative electrode layer were 0.79 μm. The average grain size ratio in each of the positive electrode layer and the negative electrode layer was 10.29.

In Comparative Example 3, the average grain size of the positive electrode active material in the positive electrode layer and the average grain size of the negative electrode active material in the negative electrode layer were 0.30 μm. The average grain size of the solid electrolyte in the positive electrode layer and the average grain size of the solid electrolyte in the negative electrode layer were 0.79 μm. The average grain size ratio in each of the positive electrode layer and the negative electrode layer was 0.38.

(Porosity) Next, the porosity of each of the positive electrode layer and negative electrode layer was measured for each of Examples 1 to 6 and Comparative Examples 1 to 3. In Example 1, the porosity of the positive electrode layer and the negative electrode layer was 4.9%. In Example 2, the porosity of the positive electrode layer and the negative electrode layer was 5.6%. In Example 3, the porosity of the positive electrode layer and the negative electrode layer was 6.2%. In Example 4, the porosity of the positive electrode layer and the negative electrode layer was 8.0%. In Example 5, the porosity of the positive electrode layer and the negative electrode layer was 8.4%. In Example 6, the porosity of the positive electrode layer and the negative electrode layer was 9.3%. In Comparative Example 1, the porosity of the positive electrode layer and the negative electrode layer was 11.0%. In Comparative Example 2, the porosity of the positive electrode layer and the negative electrode layer was 10.3%. In Comparative Example 3, the porosity of the positive electrode layer and the negative electrode layer was 12.2%.

If the porosity was less than 5%, it was judged to be good “o”. If the porosity was 5% or more and less than 10%, it was judged to be somewhat good “A”. If the porosity was 10% or more, it was judged to be bad “x”. In Comparative Examples 1 to 3, the porosity was judged to be bad “x”. This is considered to be because in Comparative Example 1, the average grain size of the solid electrolyte was larger than 2.5 μm, and the average grain size ratio was smaller than 0.4. This is considered to be because the average grain size ratio in Comparative Example 2 was larger than 10. This is believed to be because the average grain size ratio of Comparative Example 3 was less than 0.4 and thus smaller.

(Capacity Characteristics) Next, for each of Examples 1 to 6 and Comparative Examples 1 to 3, the capacity retention rate after 100 cycles was measured. The charge/discharge test was conducted at room temperature, and after charging at a current density of 10 μA/cm² until the voltage reached 3.4 V, there was a 10 min pause, and then the battery was discharged at the same current density until the voltage reached 0 V, and the measurement was repeated for 100 cycles. The value obtained by dividing the discharge capacity after 100 cycles by the initial discharge capacity is defined as the capacity retention rate, and if the capacity retention rate after 100 cycles was 80% or more, it was judged to be very good “double circle”. If the capacity retention rate was 70% or more and less than 80%, it was judged be good “o”. If the capacity retention rate was 60% or more and less than 70%, it was judged to be somewhat good “Δ”. And if the capacity retention rate was less than 60%, it was judged to be bad “x”.

In Comparative Examples 1 to 3, the capacity characteristics were judged to be bad “x”. This is considered to be because the porosity exceeded 10%.

The overall judgment for Examples 1 to 6 and Comparative Examples 1 to 3 will be explained. If the capacity characteristics were judged to be good “o” or very good “double circle” and the porosity of the electrode layer was judged to be good “o”, the overall judgement was judged to be very good “double circle”. If at least only the capacity characteristics was judged to be good “o” or very good “double circle”, the overall judgement was judged to be good “o”. If at least only the capacity characteristics was judged to be somewhat good “A”, the overall judgement was judged to be somewhat good “Δ”. If at least the capacity characteristics was judged to be bad “x”, the overall judgment was judged to be bad “x”. The results are shown in Table 1.

TABLE 1

| | AVERAGE | | | | | |
|---|---|---|---|---|---|---|
| | GRAIN | AVERAGE | | | | |
| | SIZE OF | GRAIN | | | | |
| | ELECTRODE | SIZE OF | | | | |
| | ACTIVE | SOLID | AVERAGE | | CAPACITY | |
| | MATERIAL | ELECTROLYTE | GRAIN | | RETENTION | OVERALL |
| | [μm] | [μm] | RATIO | POROSITY | RATE | JUDGE |
| EXAMPLE 1 | 0.98 | 0.79 | 1.24 | 4.9% | 88.2% | ⊚ |
| | | | | (◯) | (⊚) | |
| EXAMPLE 2 | 3.02 | 0.79 | 3.82 | 5.6% | 85.4% | ◯ |
| | | | | (Δ) | (⊚) | |
| EXAMPLE 3 | 0.98 | 1.05 | 0.93 | 6.2% | 77.9% | ◯ |
| | | | | (Δ) | (◯) | |
| EXAMPLE 4 | 0.98 | 2.21 | 0.44 | 8.0% | 64.9% | Δ |
| | | | | (Δ) | (Δ) | |
| EXAMPLE 5 | 6.99 | 0.79 | 8.85 | 8.4% | 61.3% | Δ |
| | | | | (Δ) | (Δ) | |
| EXAMPLE 6 | 0.49 | 0.79 | 0.62 | 9.3% | 63.9% | Δ |
| | | | | (Δ) | (Δ) | |
| COMPARATIVE | 0.98 | 2.66 | 0.37 | 11.0% | 45.3% | X |
| EXAMPLE 1 | | | | (X) | (X) | |
| COMPARATIVE | 8.13 | 0.79 | 10.29 | 10.3% | 21.0% | X |
| EXAMPLE 2 | | | | (X) | (X) | |
| COMPARATIVE | 0.3 | 0.79 | 0.38 | 12.2% | 55.4% | X |
| EXAMPLE 3 | | | | (X) | (X) | |

Note that for each of Examples 1 to 6 and Comparative Examples 1 to 3, the area occupation rate of the solid electrolyte in the positive electrode layer and the area occupation rate of the solid electrolyte in the negative electrode layer were measured. In Example 1, the area occupation rate of the solid electrolyte in the positive electrode layer and the area occupation rate of the solid electrolyte in the negative electrode layer were 45%. In Example 2, the area occupation rate of the solid electrolyte in the positive electrode layer and the area occupation rate of the solid electrolyte in the negative electrode layer were 42%. In Example 3, the area occupation rate of the solid electrolyte in the positive electrode layer and the area occupation rate of the solid electrolyte in the negative electrode layer were 41%. In Example 4, the area occupation rate of the solid electrolyte in the positive electrode layer and the area occupation rate of the solid electrolyte in the negative electrode layer were 39%. In Example 5, the area occupation rate of the solid electrolyte in the positive electrode layer and the area occupation rate of the solid electrolyte in the negative electrode layer were 36%. In Example 6, the area occupation rate of the solid electrolyte in the positive electrode layer and the area occupation rate of the solid electrolyte in the negative electrode layer were 36%. In Comparative Example 1, the area occupation rate of the solid electrolyte in the positive electrode layer and the area occupation rate of the solid electrolyte in the negative electrode layer were 34%. In Comparative Example 2, the area occupation rate of the solid electrolyte in the positive electrode layer and the area occupation rate of the solid electrolyte in the negative electrode layer were 34%. In Comparative Example 3, the area occupation rate of the solid electrolyte in the positive electrode layer and the area occupation rate of the solid electrolyte in the negative electrode layer were 34%.

(Reference Examples 1 to 6) In Reference Examples 1 to 6, all solid batteries were manufactured using the same procedures as Examples 1 to 6 and Comparative Examples 1 to 3, and under the manufacturing conditions of Example 1, the mixing ratio of the electrode mixture was changed so that only the area occupation rate of the solid electrolyte in the electrode layer was different. The charge/discharge test was conducted at room temperature, and after charging at a current density of 10 μA/cm² until the voltage reached 3.4 V, the initial discharge capacity was measured by repeating the discharge at the same current density with a 10-minute pause, until the voltage reached 0 V. Thereafter, the capacity per unit cell was calculated. And if the initial capacity per unit cell was 15 μAh or more, it was judged to be “double circle”, if the initial capacity was 5 μAh or more and less than 15 μAh, it was judged to be “o”, and if the initial capacity per unit cell was less than 5 μAh, it was judged to be “Δ”. The results are shown in Table 2. Note that Table 2 also lists the measurement results of the porosity of each of the positive electrode layer and the negative electrode layer.

TABLE 2

| | AREA | | | |
|---|---|---|---|---|
| | OCCUPANCY | | | |
| | RATIO OF | POROSITY | | |
| | SOLID | OF ELEC- | INITIAL | |
| | ELECTRO- | TRODE | DISCHARGE | |
| | LYTE | LAYER | CAPACITY | |
| | (%) | (%) | (μAh) | JUDGE |
| REFERENCE | 50 | 6.1 | 18 | ⊚ |
| EXAMPLE 1 | | | | |
| REFERENCE | 43 | 7.7 | 16 | ◯ |
| EXAMPLE 2 | | | | |
| REFERENCE | 64 | 5.3 | 13 | ◯ |
| EXAMPLE 3 | | | | |
| REFERENCE | 32 | 10.6 | 9 | ◯ |
| EXAMPLE 4 | | | | |
| REFERENCE | 81 | 4.4 | 4 | Δ |
| EXAMPLE 5 | | | | |
| REFERENCE | 24 | 11.4 | 3 | Δ |
| EXAMPLE 6 | | | | |

Reference Example 1 is an example in which the initial discharge capacity per unit cell was 18 μAh when the area occupation rate of the solid electrolyte was 50%, and was judged to be “double circle”. Reference Example 2 is an example in which the initial discharge capacity per unit cell was 16 μAh when the area occupation rate of the solid electrolyte was 43%, and was judged to be “o”. Reference Example 3 is an example in which the initial discharge capacity per unit cell was 13 μAh when the area occupation rate of the solid electrolyte was 64%, and was judged to be “o”. Reference Example 4 is an example in which the initial discharge capacity per unit cell was 9 μAh when the area occupation rate of the solid electrolyte was 32%, and was judged to be “o”. Reference example 5 is an example in which the initial discharge capacity per unit cell was 4 μAh when the area occupation rate of the solid electrolyte was 81%, and was judged to be “Δ”. Reference Example 6 is an example in which the initial discharge capacity per unit cell was 3 μAh when the area occupation rate of the solid electrolyte was 24%, and was judged to be “Δ”.

Although the embodiments of the present invention have been described in detail, it is to be understood that the various change, substitutions, and alterations could be made hereto without departing from the spirit and scope of the invention.

### DESCRIPTION OF THE REFERENCE NUMERALS

10 Positive electrode layer
11 Positive electrode active material
12 Solid electrolyte
13 First current collector layer
20 Negative electrode layer
21 Negative electrode active material
22 Solid electrolyte
23 Second current collector layer
30 Solid electrolyte layer
40a First external electrode
40b Second external electrode
50 Cover layer
51 Solid electrolyte green sheet
52 Internal electrode paste
53 Reverse pattern
54 Cover sheet
55 External electrode paste
60 Multilayer chip
100, 100a All solid battery

1. An all solid battery comprising:
a solid electrolyte layer that includes a first solid electrolyte;
a positive electrode layer that is provided on a first main face of the solid electrolyte layer and includes a positive electrode active material and a second solid electrolyte; and
a negative electrode layer that is provided on a second main face of the solid electrolyte layer and includes a negative electrode active material and a third solid electrolyte,
wherein, in at least one of the positive electrode layer or the negative electrode layer, an average grain size of the second solid electrolyte or the third solid electrolyte is 2.5 μm or less, and an average grain size ratio of an average rain size of the positive electrode active material to an average grain size of the second solid electrolyte or an average grain size ratio of the negative electrode active material to an average grain size of the third solid electrolyte is 0.4 or more and 10 or less.

2. The all solid battery as claimed in claim 1, wherein, in the at least one of the positive electrode layer or the negative electrode layer, an area occupancy ratio of the second solid electrolyte or the third solid electrolyte in a cross section viewed from a direction orthogonal to a direction in which the positive electrode layer faces the negative electrode layer is 25% or more and 75% or less.

3. The all solid battery as claimed in claim 1, wherein the average grain size of the second solid electrolyte or the third solid electrolyte is 0.05 μm or more.

4. The all solid battery as claimed in claim 1, wherein the porosity in the at least one of the positive electrode layer or the negative electrode layer is 10% or less.

5. The all solid battery as claimed in claim 1, wherein the second solid electrolyte or the third solid electrolyte is phosphate-based solid electrolyte.

6. The all solid battery as claimed in claim 1, wherein the second solid electrolyte or the third solid electrolyte has a NASICON type crystal structure.

7. The all solid battery as claimed in claim 1, wherein the positive electrode active material includes Co and P.

8. The all solid battery as claimed in claim 7, wherein the second solid electrolyte or the third solid electrolyte includes Co.

9. The all solid battery as claimed in claim 7, wherein the positive electrode active material includes at least one of LiCoPO₄, LiCo₂P₃O₁₀, Li₂CoP₂O₇ or Li₆Co₅(P₂O₇)₄.
